(19) United States
(12) Patent Application Publication
(10) Pub. No.: US 2016/0289005 A1
(43) Pub. Date: Oct. 6, 2016

(54) CONVEYOR SYSTEM FOR A MACHINE

(71) Applicant: Caterpillar Paving Products Inc., Brooklyn Park, MN (US)

(72) Inventors: Colton John Hirman, Rosemount, MN (US); Tim Lindholm, Blaine, MN (US); Alan Hsieh, Brooklyn Park, MN (US); Jason Bjorge, Blaine, MN (US)

(73) Assignee: Caterpillar Paving Products Inc., Brooklyn Park, MN (US)

(21) Appl. No.: 15/175,721

(22) Filed: Jun. 7, 2016

(51) Int. Cl. B65G 21/20; E01C 23/12; E01C 23/088

(52) U.S. Cl. CPC B65G 21/2081; E01C 23/088; E01C 23/127

(57) ABSTRACT

A conveyor system for a machine includes a conveyor belt adapted to convey material from one end to another. A side plate is disposed along an edge of the conveyor belt. A seal having a first edge and a second edge is in contact with the conveyor belt. A pressure applicator is mounted to the side plate. The pressure applicator is adapted to apply a pressure on the seal to maintain the second edge of seal in contact with the conveyor belt.

### TECHNICAL FIELD

The present disclosure relates to a conveyor system. More specifically, the present disclosure relates to a seal for a conveyor system.

### BACKGROUND

Asphalt-surfaced roadways have been built to facilitate vehicular travel. Depending upon usage density, base conditions, temperature variation, moisture variation, and/or physical age, the surface of the roadways can eventually become misshapen, non-planar, unable to support wheel loads, or otherwise unsuitable for vehicular traffic. In order to rehabilitate the roadways for continued vehicular use, spent asphalt is removed in preparation for resurfacing.

Cold planers, sometimes also called road mills or scarifiers, are examples of machines that typically include a frame quadrilaterally supported by tracked or wheeled drive units. The frame supports an engine, an operator's station, and a milling drum. The milling drum, fitted with cutting tools, is rotated through a suitable interface by the engine to break up the surface of the roadway. Generally, the cold planer also includes a conveyor system that is designed to carry the milled material that has been cut from the roadway by the rotating drum to a location in front of, to the rear of or beside the machine for deposit into a truck for removal from the site.

The conveyor system may include a conveyor belt configured to convey material away from the milling drum. The conveyor system may include side walls to ensure the milled material does not fall sideways. Seals may also be used to ensure effective sealing between the conveyor belt and the side walls. However, the seals wear over time and may not be able to provide effective sealing after enough wear and tear.

U.S. Pat. No. 5,513,743 describes a skirt seal arrangement for a conveyor belt which includes an elongate track element and an elongate skirt seal. The skirt seal has a base which is slidably engageable with the track element and a lower edge which is engageable in sealing contact with an opposing surface of the conveyor belt. The track element is manually adjusted via bolts or any other arrangement to keep the seal engaged with a conveyor belt. The seal needs to be manually adjusted to account for wear and tear over time.

### SUMMARY

In an aspect of the present disclosure, a conveyor system for a machine is provided. The conveyor system includes a conveyor belt adapted to convey material from one end to another. The conveyor system includes a side plate disposed along an edge of the conveyor belt. The conveyor system further includes a seal having a first edge and a second edge. The second edge is in contact with the conveyor belt. A pressure applicator mounted to the side plate is adapted to apply a pressure on the seal to maintain the second edge of seal in contact with the conveyor belt.

### BRIEF DESCRIPTION OF DRAWINGS

FIG. 1 shows a diagrammatic view of a machine having a conveyor assembly, in accordance with an embodiment of the present disclosure;

FIG. 2 shows a perspective view of the conveyor assembly including a sectional plane AA′, in accordance with an embodiment of the present disclosure;

FIG. 3 shows a front view of the conveyor assembly obtained by taking a section along the plane AA′ of FIG. 2, in accordance with an embodiment of the present disclosure; and

FIG. 4 shows a side view of the conveyor assembly, in accordance with an embodiment of the present disclosure.

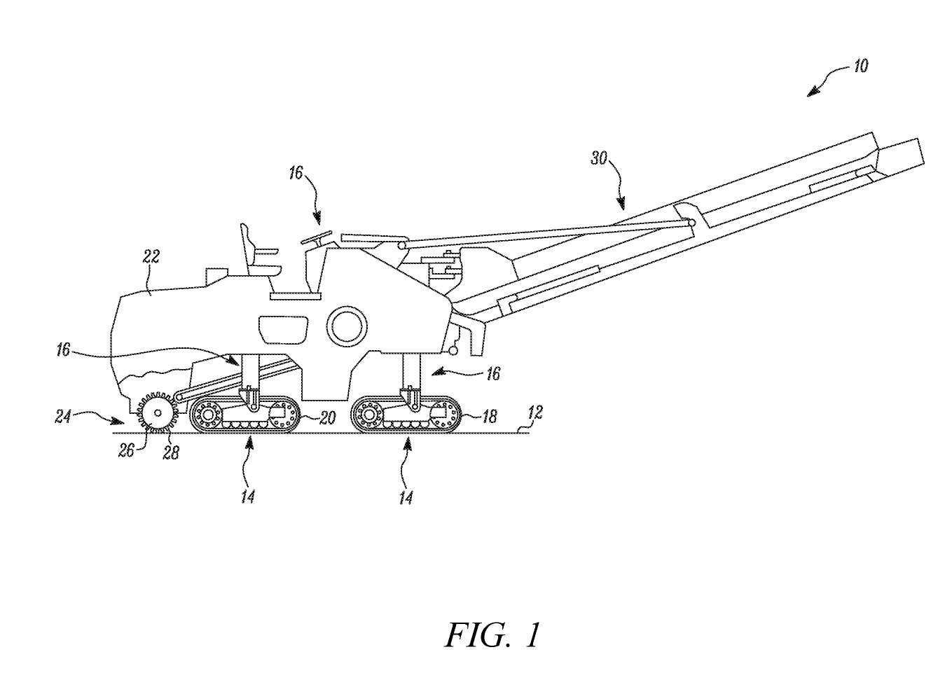

### DETAILED DESCRIPTION

Wherever possible, the same reference numbers will be used throughout the drawings to refer to same or like parts. FIG. 1 illustrates an exemplary machine 10, in accordance with the present disclosure. The machine 10 may be a mobile machine operable to move along a ground surface 12 that is underneath the machine 10. The ground surface 12 may be a man-made surface, such as a road, parking lot, concrete cement, or other paved surface.

The machine 10 may be configured to perform various functions when traveling over the ground surface 12. In the embodiment shown in FIG. 1, the machine 10 is a cold planer. The machine 10 may cut or grind a top layer of concrete, asphalt, or similar material, to a depth that is typically between 1″ to 14″ below the ground surface 12.

The machine 10 includes a support system 14 to support the machine 10 on the ground surface 12 and a steering system 16 to steer the machine 10 while moving along the ground surface 12. The support system 14 includes one or more front ground-engaging components 18 and one or more rear ground-engaging components 20 for moving along the ground surface 12. FIG. 1 shows one of the front ground-engaging component 18 on a right side of the machine 10, as well as one of the rear ground-engaging component 20 on the right side of the machine 10. The machine 10 may include similar front and rear ground-engaging components on a left side as well. Each ground-engaging component 18, 20 may include any device or devices configured to move across the ground surface 12, including but not limited to track units, wheels, and skids.

The machine 10 further includes a frame 22 which may serve to tie together and support other components and systems of the machine 10. In addition to the frame 22, the machine 10 may have various other components and systems that serve various purposes. In the embodiment where the machine 10 is a cold planer, the frame 22 supports a material removal mechanism 24 to cut or grind the top layer of the ground surface 12. The material removal mechanism 24 is a grinding mechanism which includes a rotor 26 with a plurality of teeth 28 for grinding the ground surface 12. However, the material removal mechanism 24 is not limited to such an arrangement. Although FIG. 1 shows the material removal mechanism 24 housed in a central, lower portion of the machine 10, the material removal mechanism 24 may he disposed in various places on the machine 10. Alternatively or additionally, the machine 10 may include one or more supplementary grinding mechanisms (not shown) located in rear and/or forward positions in the machine 10.

The frame 22 also supports a conveyor system 30 located adjacent to the material removal mechanism 24. The conveyor system 30 receives the material removed from the ground surface 12 through the material removal mechanism 24 and further conveys the material to a location off of the machine 10, such as to a receiver (not shown), for e.g., another truck separate from the machine 10). The truck may be a dump truck that includes a box. The dump truck may drive next to the machine 10 during grinding of the ground surface 12, at approximately the same speed as the machine 10, so that the material is conveyed by the conveyor system 30 and dropped into the box.

The machine 10 may also include one or more power sources (not shown) for powering the material removal mechanism 24, the conveyor system 30, and/or various other components and systems of the machine 10. For example, the machine 10 may include one or more internal combustion engines, batteries, fuel cells, or the like for providing power. The machine 10 may also include various provisions for transmitting power from such power sources to the material removal mechanism 24 and/or various other components of the machine 10. For example, where the machine 10 includes an internal combustion engine as a power source, the machine 10 may include one or more mechanical or electrical power-transmission devices, such as, mechanical transmissions, hydraulic pumps and motors, and/or electric generators and motors, for transmitting power from the engine to the material removal mechanism 24 and the conveyor system 30.

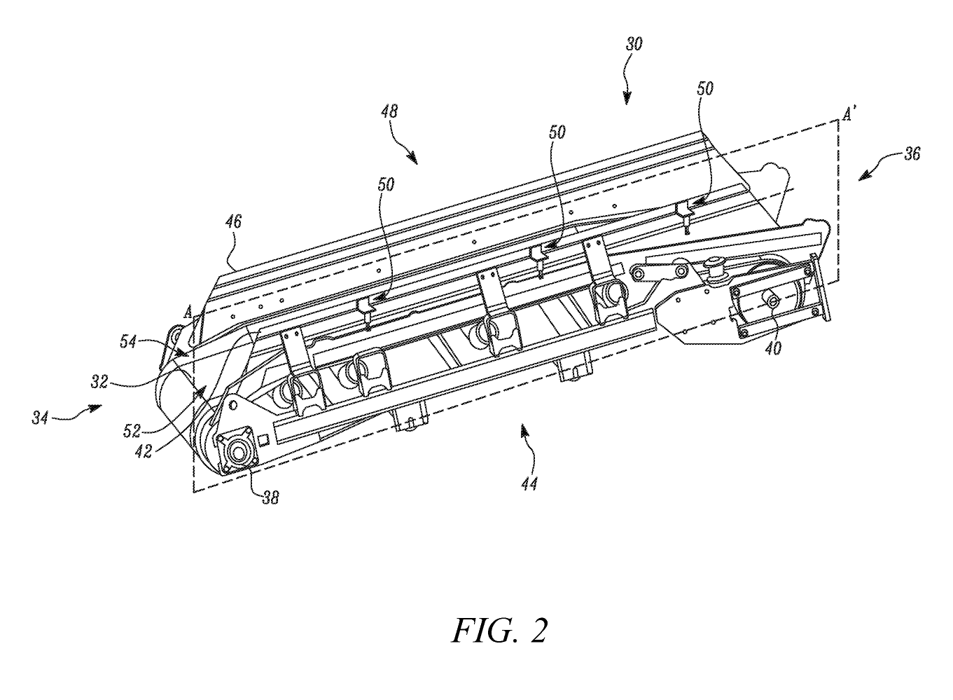

The conveyor system 30 receives material from the material removing mechanism 24 and conveys the material to the receiver. Referring to FIG. 2, the conveyor system 30 includes a conveyor belt 32. The conveyor belt 32 may be made up of any material suitable for the need of the present application. The conveyor belt 32 receives the material to be conveyed at a first end 34 from the material removing mechanism 24 and transfers the material to a second end 36 in order to pass the material to the receiver. The conveyor belt 32 is wound around a pair of rollers including a first roller 38 at the first end 34 and a second roller 40 at the second end 36 of the conveyor belt 32. It may be contemplated that the conveyor system 30 may include additional rollers as well to provide stability to the conveyor belt 32 as per the need of the application. The pair of rollers 38, 40 may be powered by the one or more power sources. The power sources provide power to the pair of rollers 38, 40 (and additional rollers if there are any) and the conveyor belt 32 rotates accordingly to transfer material from the first end 34 to the second end 36.

The conveyor system 30 includes a pair of side plates located along edges of the conveyor belt 32. The pair of side plates includes a first side plate 42 located on a first side 44 of the conveyor system 30 and a second side plate 46 located on a second side 48 of the conveyor system 30. The first side plate 42 extends from the first end 34 to the second end 36 of the conveyor belt 32 on the first side 44 of the conveyor system 30. The second side plate 46 extends from the first end 34 to the second end 36 of the conveyor belt 32 on the second side 48 of the conveyor belt 32. The pair of side plates 42, 46 may be mounted to the conveyor system 30 so that the pair of side plates 42, 46 prevents the material on the conveyor belt 32 from falling over from the first and second sides 44, 48 of the conveyor system 30. The conveyor system also includes a single or multiple pressure applicators 50.

An imaginary sectional plane AA′ divides the conveyor system 30 in a first part 52 and a second part 54. The plane AA passes through the conveyor belt. The first part 52 extends from the plane AA′ towards the first side 44 of the conveyor system 30 and the second part 54 extends from the plane AA′ towards the second side 48 of the conveyor system 30. Further structural details of the conveyor system 30 will be explained with respect to the first part 52 only. It should be understood that the second part 54 will have exactly similar construction as the first part 52.

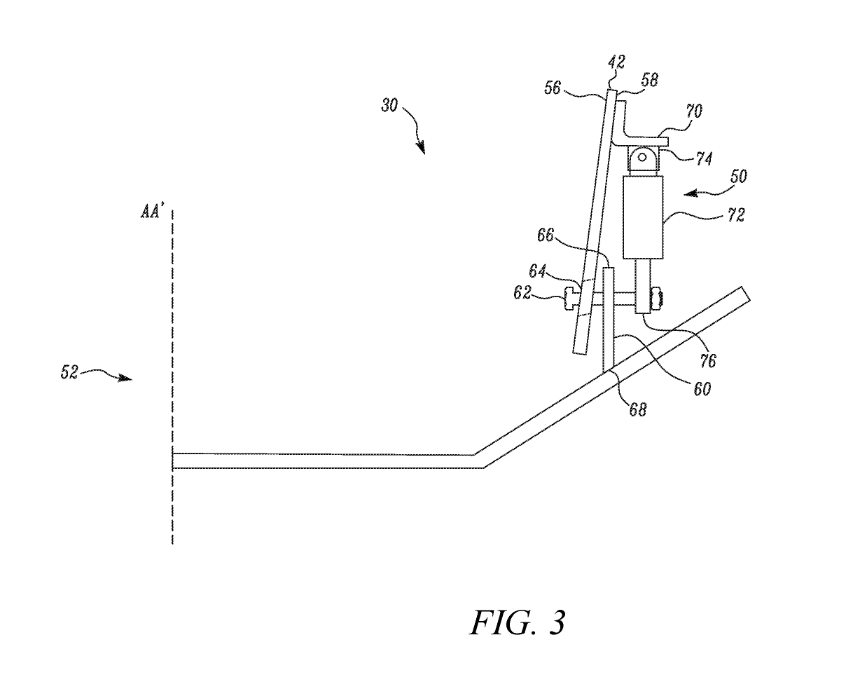

FIG. 3 illustrates structural details of the first part 52 of the conveyor system 30. The first part 52 of the conveyor system 30 includes the first side plate 42. The first side plate 42 has a pair of surfaces including an inside surface 56 and an outside surface 58. The inside surface 56 is defined as the surface facing the conveyor belt 32 and the outside surface 58 is defined as the surface opposite to the inside surface 56. The first side plate 42 is mounted on the conveyor system 30 such that the first side plate 42 is not in contact with the conveyor belt 32. There is a slight vertical gap between the conveyor belt 32 and the first side plate 42. A seal 60 is provided adjacent to the outside surface 58 of the first side plate 42 to prevent any material falling from the vertical gap. The seal 60 may be made of any wearable material such as rubber, polymer etc. suitable to the need of the present application.

The seal 60 is attached to the first side plate 42 through a bolt 62. Any other mechanical fastener suitable to the present disclosure may also be used to attach the seal 60 to the first side plate 42. The first side plate 42 includes a longitudinal slot 64. The bolt 62 passes through the longitudinal slot 64 to attach the seal 60 to the first side plate 42 and extends towards the first side 44 of the conveyor system 30 away from the seal 60. In an embodiment, the seal 60 is attached to the first side plate 42 by toggle clamps or lobed knob system. The toggle clamps or the lobed knob system provide for easy attachment/removal of the seal 54 from the first side plate 42.

The seal 60 extends from the first end 34 of the conveyor belt 32 to the second end 36 of the conveyor belt 32. The seal 60 may be of any profile such as a rectangular profile, a square profile etc. In the illustrated example, the seal 60 has a rectangular profile. The seal 60 has a first edge 66 and a second edge 68. The second edge 68 of the seal 60 is in contact with the conveyor belt 32. The second edge 68 of the seal 60 may wear owing to friction between the conveyor belt 32 and the second edge 68 of the seal 60 over a period of time. The pressure applicator 50 applies a downward pressure on the seal 60 to maintain the second edge 68 of the seal 60 in contact with the conveyor belt 32. The pressure applicator 50 is mounted on the first side plate 42. The pressure applicator 50 may be any type of a system which may apply a downward pressure on the seal 60. For example, the pressure applicator 50 may be a cylinder system, a spring system, or a gas strut system. In the illustrated embodiment, the pressure applicator 50 is a cylinder system.

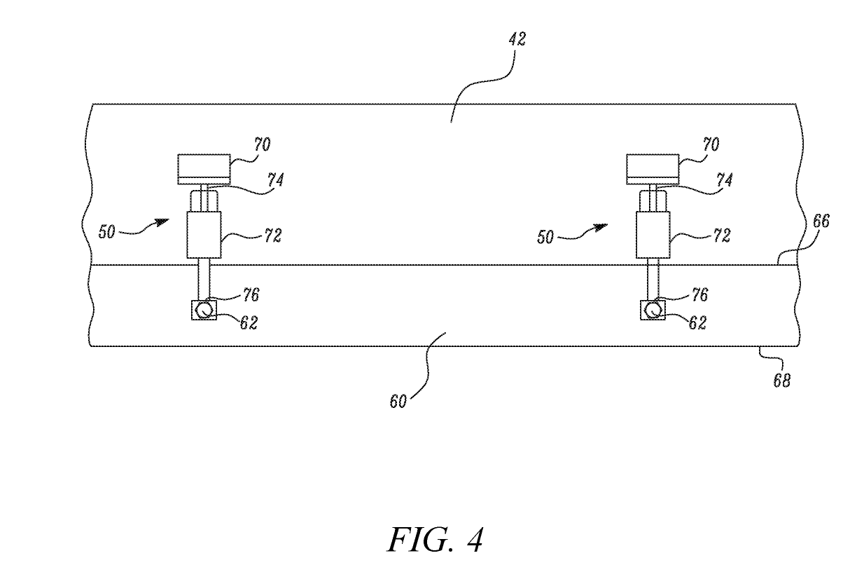

FIG. 4 shows a side view of the conveyor system 30. As the seal 60 wears over time, the pressure applicator 50 applies pressure on the seal 60 and maintains the second edge 68 of the seal 60 in contact with the conveyor belt 32. With combined reference to FIGS. 3 & 4, the pressure applicator 50 includes a bracket 70 attached to the first side plate 42. The bracket 70 may be attached to the first side plate 42 by welding, clamping or any other suitable means applicable to the present disclosure. The bracket 70 may be an L-shaped bracket. The bracket 70 may be of any other shape as well suitable to the present disclosure. The pressure applicator 50 further includes a cylinder 72. The cylinder 72 has a first end 74 attached to the bracket 70 and a second end 76 attached to the bolt 62. The cylinder 72 may be loaded so as to apply pressure on both the first end 74 and the second end 76 by a hydraulic fluid, a pneumatic fluid or a spring etc. As the first end 74 is attached to the bracket 70, the cylinder applies pressure on the second end 76. The cylinder 72 applies pressure on the seal 60 through the bolt 62 so as to keep the second edge 68 of the seal 60 in constant contact with the conveyor belt 32. The cylinder 72 may also be attached to the seal 60 at the first edge 66. In such an arrangement, the cylinder 72 will apply pressure on the first edge 66 of the seal 60 to maintain the second edge 68 of the seal 60 in contact with the conveyor belt 32. The cylinder 72 may also apply pressure to the seal 60 in any other suitable manner without deviating from the scope of the present disclosure.

### INDUSTRIAL APPLICATION

Cold planer or similar machines are used to break up or treat asphalt or road surfaces. The material which has been cut away needs to be transferred away from the machines. Conveyor systems are used in combination with material removing mechanisms to move the material away from the machine. Conveyor systems use seals to avoid spillage from the conveyor system. Seals wear out after prolonged usage over time and need to be constantly checked for wear and subsequent adjustment.

The present disclosure provides a solution to the aforementioned problem by providing means to automatically adjust the seal relative to the conveyor belt. The conveyor system 30 includes the first side plate 42 located along the edge of the conveyor belt 32. The seal 60 is located adjacent to the outside surface 58 of the first side plate 42 and extends from the first end 34 to the second end 36 of the conveyor belt 32. The pressure applicator 50 applies downward pressure on the seal 60 so as to maintain the second edge 68 of the seal 60 in contact with the conveyor belt 32. As the seal 60 wears, the pressure applicator 50 applies downward pressure and the seal 60 maintains contact with the conveyor belt 32. The conveyor system 30 may include a single or multiple pressure applicators 60. The pressure applicator 50 may be any one of the spring system, the cylinder system, or the gas strut system. The seal 60 maintaining constant contact with the conveyor belt 32 prevents any spillage of material being conveyed from sides of the conveyor belt 32. Also, productivity levels of the machine 10 are improved and manual adjustment of the seal 54 may not be required.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A conveyor system for a machine, the conveyor system comprising:
a conveyor belt adapted to convey material from one end to another;
a side plate disposed along an edge of the conveyor belt;
a seal having a first edge and a second edge, wherein the second edge is in contact with the conveyor belt; and
a pressure applicator mounted to the side plate, the pressure applicator adapted to apply a pressure on the seal to maintain the second edge of seal in contact with the conveyor belt.

2. The conveyor system of the claim 1, wherein the pressure applicator includes at least one of a spring system, a grease cylinder system, or a gas strut system.
